(19) United States
(12) Patent Application Publication
(10) Pub. No.: US 2008/0265737 A1
(43) Pub. Date: Oct. 30, 2008

(54) Plasma Chamber Cathode and Outer Ring Made of Silicon Material

(75) Inventors: Jong-Sik Bae, Kyungsangbukdo (KR); Chan Hur, Kyungsangbukdo (KR); Jae-Keuk Chung, Kyungsangbukdo (KR)

Correspondence Address: LOWE HAUPTMAN HAM & BERNER, LLP, 1700 DIAGONAL ROAD, SUITE 300, ALEXANDRIA, VA, 22314, US

(73) Assignee: WORLDEX INDUSTRY & TRADING CO., LTD., Kumi-city, Kyungsangbukdo (KR)

(21) Appl. No.: 12/089,010

(22) PCT Filed: Sep. 1, 2006
(86) PCT No.: PCT/KR2006/003472

§ 371 Date: Apr. 2, 2008

(30) Foreign Application Priority Data
Jul. 31, 2006 (KR) 10-2006-0072177

(51) Int. Cl. H01J 1/00

(52) U.S. Cl. 313/326

(57) ABSTRACT

The present invention relates to a plasma chamber cathode and outer ring made of only silicon. When the anode (i.e., a voltage device) used in the plasma process of a semiconductor wafer is deformed due to the pressure of the R. F gas, the cathode coupled to the bottom of the anode must be deformed in cooperation with the anode. However, the cathode is comprised of silicon and graphite, which are elastomer-bonded. Thus, since the cathode is not flexibly deformed in cooperation with the deformation of the anode, bolts coupled to the anode, the cathode and the outer ring are broken and deviated. The graphite material easily generates particles. To solve the problem, the cathode is made of only silicon, and a plate groove and ring grooves are formed on the top portion of the cathode. A plate and rings are inserted into the plate groove and the ring grooves, respectively, so that a space portion is defined between the plate groove and the plate, and between the ring grooves and the rings. Accordingly, the cathode can be easily deformed in cooperation with the deformation of the anode. It is therefore possible to prohibit the occurrence of particles.

### TECHNICAL FIELD

The present invention relates, in general, to a plasma chamber cathode and outer ring made of a silicon material. More particularly, the present invention relates to a plasma chamber cathode and outer ring made of a silicon material, in which a cathode is configured such that it is easily deformed according to the deformation of an anode in constructing the anode and the cathode (i.e., voltage devices) used in the plasma process of a semiconductor wafer, thereby reducing a defective proportion in work and increasing a production efficiency.

### BACKGROUND ART

The prior art will now be described. Korean Patent Application No. 10-2005-0014324 discloses a cathode substrate and method of fabricating the same, in which a cathode electrode layer, an insulating layer and a gate electrode layer are sequentially laminated on a substrate, a carbon-based (graphite) emitter is formed at the bottom of a hole formed in the insulating layer, and a gate hole unit is formed in the gate electrode layer.

The gate hole unit includes a plurality of openings each having an area smaller than an opening area of the hole of the insulating layer. The respective openings are densely formed, preferably, uniformly densely formed just on the hole of the insulating layer to be opposite to the carbon-based (graphite) emitter.

That is, the material of the cathode used in the etching process of the semiconductor wafer comprises graphite and silicon that are elastomer-bonded. The graphite comprises carbon. The carbon itself has the property of increasing the current, but serves as particles on the surface of the wafer. Consequently, the carbon not only increases a defective proportion and decreases a production yield, but also degrades the amount and quality of plasma through the anode and the cathode.

It is preferred that the cathode is fabricated of only silicon. But, the property of silicon has a low flexibility and is not easily deformed. For this reason, when the anode connected to silicon is deformed due to the pressure of a gas, the cathode is not deformed in cooperation with the anode. Bolts coupled to the anode and the cathode may be deviated and broken, resulting in a damage on the cathode.

Accordingly, there is an urgent need for the development of a cathode, which can be easily deformed in cooperation with the deformation of an anode while forming the cathode using silicon not causing particles.

### DISCLOSURE OF INVENTION

### Technical Problem

Accordingly, the present invention has been made to solve the above-mentioned problems occurring in the prior art. In general, the material of a cathode includes silicon and graphite that are elastomer-bonded. Graphite and elastomer cause the generation of particles on the surface of a wafer. Therefore, the yield is lowered and the quality of plasma through the cathode is degraded.

In order to form a cathode using only silicon and to supplement the fact that a single material of silicon is not deformed due to a low elasticity, a circular plate groove and ring grooves are formed in the cathode. A plate and rings are inserted into the plate groove and the ring grooves so that a space portion is formed between the grooves and the plate, and the rings. The cathode can be easily deformed due to the space portion in cooperation with the deformation of the anode coupled to the cathode by bolts.

Accordingly, an object of the present invention is to increase the yield of a wafer process by removing the possible occurrence of particles while maintaining elasticity.

### Advantageous Effects

The present invention relates to a plasma chamber cathode and an outer ring made of a single silicon material. In the cathode and outer ring used in the plasma process of a semiconductor wafer, an existing cathode and outer ring is made of graphite different from that of a wafer. It causes to generate particles on the surface of the wafer. Accordingly, the yield was lowered and the quality of plasma through the cathode was degraded.

In the present invention, however, a cathode is formed of only silicon and circular grooves are formed in the cathode. A plate and an outer ring are inserted into the grooves to define a predetermined gap between the grooves and the plate, and the rings. Therefore, not only the cathode and the rings have elasticity, but also the possible occurrence of particles can be eliminated. Accordingly, the present invention is advantageous in that it can increase the yield of the semiconductor wafer process.

### BRIEF DESCRIPTION OF THE DRAWINGS

FIG. 1 is a cross-sectional view showing the modification of a conventional cathode;

FIG. 2 is a cross-sectional view showing a preferred embodiment of the present invention;

FIG. 3 is a perspective view showing a preferred coupling state of the cathode according to the present invention;

FIG. 4 is a perspective view showing a preferred coupling state of the outer ring according to the present invention;

FIG. 5 is a perspective view showing a preferred embodiment of the present invention; and

FIG. 6 is a perspective view showing the construction of an outer ring according to another type of the present invention.

### DESCRIPTION ON REFERENCE NUMERALS

10: cathode
20: ring groove
30: plate groove
40: through-holes
50: bolt groove
60: plate
70: ring
80: outer ring
90: outer ring plates groove
100: outer ring plates
110: bolt
120: anode
130: small groove

### MODE FOR THE INVENTION

The construction and operation of present invention will be described below.

In the present invention, a plurality of circular plate grooves and ring grooves are formed on a top portion of a cathode 10. A plate 60 and rings 70 are inserted into plate groove and the ring grooves so that a space portion is formed between the grooves of the cathode 10, the ring grooves and the plate 60 and the rings 70. Therefore, the cathode 10 can be easily deformed according to the deformation of an anode 120 coupled to the cathode 10 by bolts 110 while not generating particles.

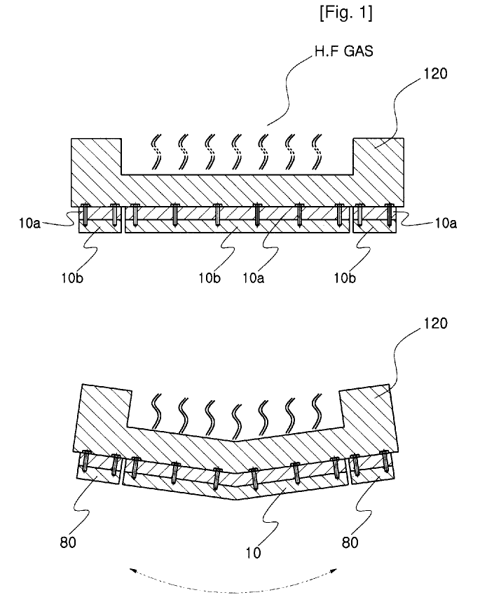

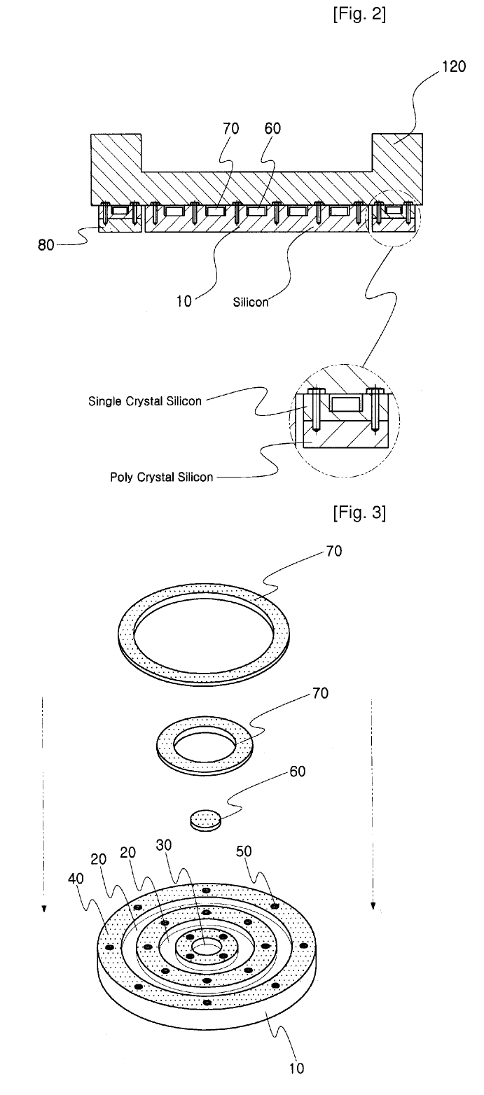

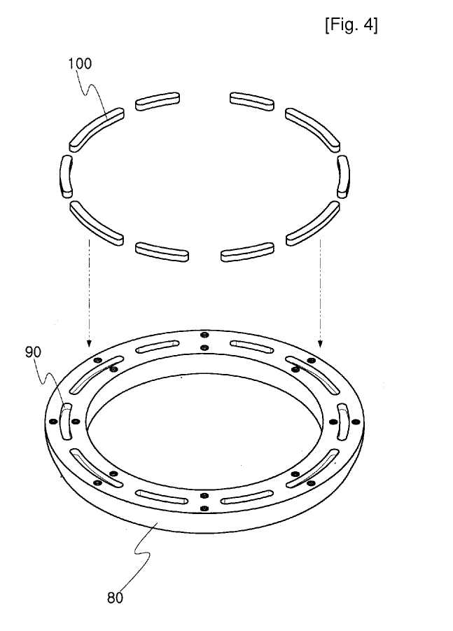

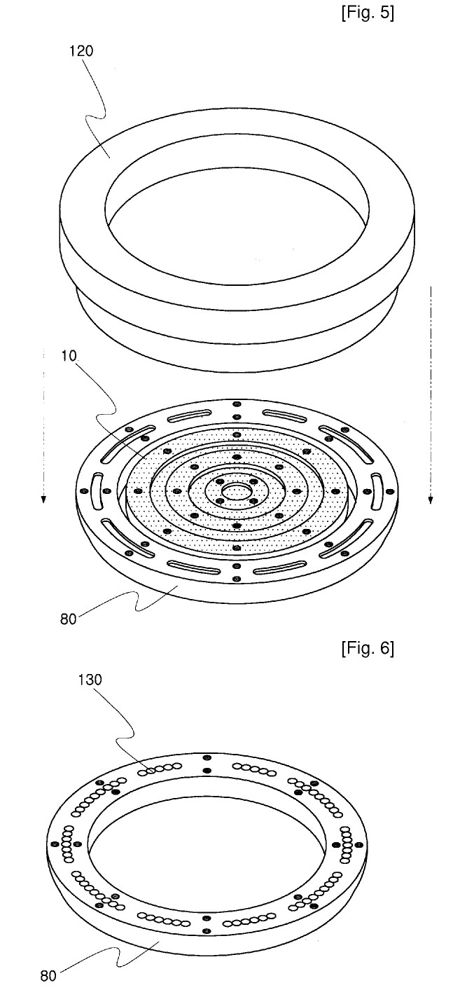

FIG. 1 is a cross-sectional view showing the modification of a conventional cathode. FIG. 2 is a cross-sectional view showing a preferred embodiment of the present invention. FIG. 3 is a perspective view showing a preferred coupling state of the cathode according to the present invention. FIG. 4 is a perspective view showing a preferred coupling state of the outer ring according to the present invention. FIG. 5 is a perspective view showing a preferred embodiment of the present invention. FIG. 6 is a perspective view showing the construction of an outer ring according to another type of the present invention.

The present invention will now be described in detail.

Referring to FIG. 1, a common etching process involves supplying a H.F gas into a chamber, forming plasma that passes through through-holes 40 of the anode 120 and the cathode 10 by applying a voltage to upper and lower electrodes of the anode 120 and the cathode 10 coupled by means of the bolts 110 (not shown), and selectively removing desired portions of the surface of the wafer using the plasma.

The cathode 10 is formed of silicon 10a and graphite 10b, which are bonded together. Graphite has been used as the material of the cathode 10 due to an excellent electrical property, but is disadvantageous in that the yield is low, a defective proportion is high and productivity is low since particles are formed on the surface of the wafer.

The cathode 10 is formed of only silicon. As shown in FIG. 1, the main material of the anode 120 is aluminum. Aluminum has the mechanical property of being easily bent even at a low pressure and temperature. If a disk-shaped cathode is formed of only silicon, the anode 120 is fluctuated according to the pressure of the H.F gas flowing into the chamber.

The cathode 10 coupled to the bottom of the anode 120 by the bolts 110 has a very low coefficient of elasticity in terms of the property of silicon and is therefore not deformed in cooperation with the anode 120. Therefore, the bolts 110 coupled to the anode 120 and the cathode 10 are broken or generate voids. It results in a damage to the anode 120 or the cathode 10.

To overcome the above problem, in the present invention, a plurality of ring grooves 20 and a plate groove 30 are formed on a top portion of the cathode 10 in which a plurality of through-holes 40 are densely disposed at predetermined distances in a circular silicon plate made of a single crystal material, as shown in FIG. 3. The respective ring grooves 20 and the plate groove 30 have a predetermined width and depth, and the respective through-holes 40 have a constant diameter and thickness.

This is because if the ring grooves and the plate groove are formed on the top of the cathode, the cathode 10 can be easily bent as the anode 120 is bent due to the spaces defined between the rings and the ring grooves, and between the plate and the plate groove. In an etching process, however, the vacuum within the chamber requires exactness. Therefore, if the ring grooves and the plate groove are formed in the cathode 10, the movement of gases may be decreased and the quality of plasma may be degraded since the vacuum space is increased and the vacuum pressure is lowered.

To address the problems, the plate 60 and the rings 70 are formed to have the same shape as those of the plate groove and the ring grooves formed in the cathode. The same through-holes as the through-holes 40 formed in the surface of the cathode 10 are formed in the surfaces of the plate 60 and the ring 70, so that the plate 60 and the ring 70 are inserted into the plate groove and the ring grooves, and then seated therein.

Furthermore, as shown in FIGS. 2 and 4, the plate 60 and the rings 70 have width and thickness smaller than those of the plate groove and the ring grooves. Therefore, although the plate 60 and the rings 70 are inserted into the plate groove and the ring grooves and then seated therein, a predetermined space portion is defined between the plate 60 and the plate groove, and between the rings 70 and the ring grooves, so that the bending is facilitated when the cathode is bent in cooperation with the anode.

In other words, the anode 120 and the cathode 10 are coupled by the bolts 110 using a common coupling method. Accordingly, the cathode 10 can be deformed in cooperation with the deformation of the anode 120 due to the space portion of the plate groove and the ring grooves of the cathode. Furthermore, the rings 70 and the plate 60 are inserted into and seated in the space formed by the ring grooves 20 and the plate groove 30. It is therefore possible to minimize a variation in an optimized vacuum pressure within an existing chamber.

An outer ring 80 is disposed at an outer circumference of the cathode 10 and serves to introduce a R.F gas, which is moved through the anode 120, into the cathode 10 and discharge the R.F gas toward the outside. The outer ring 80 is made of silicon of a single crystal material and silicon of a polycrystal material. In this case, it is difficult to form the outer ring in disk form using the silicon of the polycrystal material when the pie is 400 π.

The silicon of the single crystal material is integrally formed and the silicon of the polycrystal material coupled to the lower portion of the cathode is separately formed. Therefore, they are coupled to each other to form a ring. A location at which the outer ring 80 is formed has a shape surrounding the outer circumference of the cathode 10. The pressure of the R.F gas is concentrated on the center of the anode 120, so that bending occurs at the center of the anode 120. Further a bending occurs in the outer ring 80 located at the outer circumference of the cathode.

Therefore, a plurality of outer ring plate grooves 90 are circumferentially formed on a top surface of the outer ring 80 similarly to the plate 60 of the cathode 10 while having an overall circular shape like the ring groove 20 of the cathode 10. Outer ring plates 100 are inserted into the outer ring plate grooves 90.

As shown in FIG. 5, the cathode 10 and the outer ring 80 are coupled to the anode 120. The plate 60 and the rings 70 are inserted into the grooves of the cathode 10 and the outer ring 80 is formed at the outer circumference of the cathode 10. However, the outer ring plates 100 are also inserted and seated on the outer ring 80 and the anode 120 is seated on the cathode 10 and the outer ring 80. Therefore, bolt grooves 50 formed in the cathode 10 and the outer ring 80 are securely fixed by the plurality of bolts 110.

Through the above process, the H.F gas is injected into the anode 120. In order to cope with the bending phenomenon of the anode 120 due to the pressure of the H.F gas, the cathode 10 and the outer ring 80 made of only silicon having a very low elasticity can be deformed in cooperation with the deformation of the anode 120 due to the space portion defined between the plate and the plate groove, and between the rings and the ring grooves of the cathode 10 and the outer ring 80.

The space portion defined between the plate and the plate groove, and between the rings and the ring grooves is formed to the extent that it does not influence the vacuum pressure within an existing chamber.

Furthermore, a plurality of circular small grooves 130 may be formed consecutively on a top surface of the outer ring 80 without forming the grooves and the plate in the substrate in order to obtain the same effect, as shown in FIG. 6. Groups of the consecutive small grooves 130 are disposed at the circumferential center of the top surface of the outer ring in such a manner as to be spaced apart from one another at predetermined distances. Accordingly, the groves 130 can be deformed due to the pre-determined gaps of the small grooves 130, and variation in the vacuum pressure within the chamber can be minimized.

### INDUSTRIAL APPLICABILITY

The present invention relates to the plasma chamber cathode and outer rings of a single silicon material. In a cathode and outer rings used in the plasma process of a semiconductor wafer, the material of an existing cathode and outer rings is graphite different from that of a wafer. It causes to generate particles on the surface of the wafer. Accordingly, the yield was lowered and the quality of plasma through the cathode was degraded.

In the present invention, however, a cathode is formed using only silicon and annular ring grooves are formed on the top of the cathode. A plate and rings are inserted into the plate groove and the ring grooves to form a predetermined gap defined between the plate and the plate groove, and between the rings and the ring grooves. Therefore, not only the cathode and the rings have elasticity, but also the possible occurrence of particles can be eliminated. Accordingly, the present invention is advantageous in that it can increase the yield of the semiconductor wafer process.

1. A cathode made of only silicon and used in a semiconductor etching process, the cathode comprising:
through-holes 40 densely formed in a surface of the cathode at predetermined distances; and
annular ring grooves 20 and a plate groove 30 formed on a top portion of the cathode, the ring grooves and the plate groove being made of only silicon and closely coupled to an anode.

2. The cathode of claim 1, further comprising a plate 60 and rings 70 inserted into and seated in the plate groove 30 and the ring grooves 20, respectively,
wherein the plate 60 and the rings 70 have the through-holes 40 densely formed therein, have width and thickness smaller than those of the plate groove 30 and the ring grooves 20, and are integrally formed of only silicon.

3. An outer ring for a cathode, which is made of only single and used in a semiconductor etching process, the outer ring comprising:
through-holes 40 densely formed in a surface of the outer ring at predetermined distances; and
outer ring plate grooves 90 formed in the outer ring,
wherein the outer ring has a predetermined diameter and is made by bondedly coupling silicon of a separate polycrystal material to a single circular plate of silicon of a single crystal material.

4. The outer ring of claim 3 further comprising outer ring plates 100 inserted into the outer ring plate grooves 90, respectively, and having width and thickness smaller than those of the outer ring plate grooves 90, wherein the outer ring plates 100 are made of single crystal silicon or polysilicon silicon.

5. An outer ring for a cathode, which is made of only single and used in a semiconductor etching process, the outer ring comprising:
through-holes 40 densely formed in a surface of the outer ring at predetermined distances; and
a plurality groups of consecutive circular small grooves 130 formedat the circumferential center of the top surface of the outer ring coupled to an anode in such a manner as to be spaced apart from one another at regular distances.
wherein the outer ring has a predetermined diameter and is made by bondedly coupling silicon of a separate polycrystal material to a single circular plate of silicon of a single crystal material.

6. The outer ring of claim 5, wherein the circular small grooves 130 are not excavated grooves having a wide area, but are formed linearly.
